(19) United States
(12) Patent Application Publication
(10) Pub. No.: US 2007/0118645 A1
(43) Pub. Date: May 24, 2007

(54) Method and apparatus for theft protection for devices in a network

(75) Inventor: Thomas A.H.M. Suters, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,150

(22) PCT Filed: Nov. 11, 2004
(86) PCT No.: PCT/IB04/52388

§ 371 Date: May 12, 2006

Related U.S. Application Data
(60) Provisional application No. 60/519,810, filed on Nov. 13, 2003.

(51) Int. Cl. G06F 15/173

(52) U.S. Cl. 709/225

(57) ABSTRACT

A plurality of methods, apparatus and computer programs for detecting both the authorized and unauthorized removal of a plurality of consumer electronic devices configured in a network based on these devices being in a protected or unprotected state. In a preferred embodiment, a thus protected networked consumer electronic device considers itself removed from the network without authorization if its protection state is “protected” when detecting its own removal from the network and it considers itself removed from the network with authorization if its protection state is unprotected when detecting its own removal from the network. Alternatively, another device monitors the protected device's protection state and considers the device removed from the network without authorization if the last known protection state is “protected” when the other device detects the removal of that device from the network and considers the device removed from the network with authorization if the last known protection state is “unprotected” when the other device detects the removal of that device from the network. A response is generated to the user that distinguishes between removal with and without authorization.

The present invention relates to a method and apparatus for theft protection for consumer electronic devices configured in a network such as a wired or wireless business or in-home network.

Consumer electronic devices that are network ready offer attractive targets for unauthorized removal or theft thereof. These devices are not readily distinguishable from one another and easily fit into another network environment without giving any outward indication that they are stolen or at least have been moved from their current location without proper authorization.

These devices can be widely distributed and therefore cannot always be placed in environments that are intended to reduce their attractiveness to thieves. In fact, many such devices are placed where they are particularly attractive targets and have little if any protection from being surreptitiously removed, i.e., stolen.

Device discovery mechanisms to detect device insertion and removal in networks are well known e.g.:
Network specific hardware based: e.g. IEEE-1394 bus reset.
SW based by sending data messages over the network
   1. push based: a device broadcasts or registers its presence in the network by broadcasting regular announcement messages (e.g. UPnP) or regularly registering itself over the network in a (central or distributed) database or registry (e.g. Jini). Removal is detected by another device when no broadcast message is received within some pre-set time interval or by the database if the registration is not renewed within some pre-set time interval.
   2. pull based where a “network manager device” polls other devices to see if they reply. Removal is detected if no reply is received within some time interval. This time interval does not need to be pre-set but depends on network parameters such as network latency and transmission speed.
   3. guarding based where a device expects to regularly receive a message containing some predetermined specific information such as a specific network identifier or an identification of neigboring nodes. The device detects its own removal from the network when it does not receive this predetermined information within some time interval.

In known network theft protection systems, device discovery mechanisms as described above are used by a networked consumer device to detect its own removal or the removal of another networked device from the network and, if a removal is detected, considers itself respectively the other device as stolen. The remove device then e.g. enters into a mode where it cannot be used any longer (like car radios with code protection) or generates an alarm. Alternatively a device detecting the removal of another device may generate an alarm.

With the advent of networked personal CE devices such as portable MP3 players, PDAs and mobile phones, an equally easy to deploy and unobtrusive anti-theft system is needed to protect these devices but that is also capable of detecting the authorized removal of devices from the in-home network and where the system responds accordingly e.g. by not generating an alarm. An authorized removal occurs e.g. when a user takes his portable MP3 player, PDA or mobile phone out of the home.

The present invention provides a mechanism to detect whether or no a networked consumer electronic device has been removed from the network with or without authorization, based on the protection state of the device and to respond accordingly. An unauthorized removal indicates a possible theft of the device.

The network can be any type of network capable of sending messages. Specifically intended are wireline or wireless networks, such as networks according to the Bluetooth Special Interest Group specification, the IEEE 802 series of standards, in particular wired Ethernet (IEEE std 802.3), wireless Ethernet (IEEE std 802.11 a/b/g), Ultra Wide Band (IEEE std 802.15.3) and Zigbee (IEEE std 802.15.4) and a network comprising a combination of two or more of the above technologies.

By contrast to known theft protection systems that do not provide for maintaining a protection state concerning a device on the device itself, the present invention provides a system and method for placing a networked CE device into a “protected” or unprotected” state (i.e., the device protection state) that is known to the device itself.

According to the present invention detection of removal and insertion of a device into the network is done in a further unspecified mechanism outside the scope of the present invention e.g. the known device discovery mechanisms as described above or any other suitable mechanism. According to the present invention the protection state (“protected” or “unprotected”) of a device is communicated over the network in a further unspecified way that is outside the scope of the present invention e.g. as part of the messages used by the known device discovery mechanisms described above or by using any other suitable protocol. A device generates an alarm to indicate its unauthorized removal from the network when it detects its own removal from the network while being in the protected state. Alternatively a device generates an alarm if it detects the unauthorized removal of another device from the network whose last known protection state was “protected”. When not in the “protected” state respectively when the last known protection state was not “protected”, no alarm will be generated. but possibly an alert indicating the authorized removal of the device from the network instead of an unauthorized removal of the device.

According to the present invention a user can under the user's control set the protection state of a device to “protected” (thereby disabling its authorized removal from the network) and reset the state to “unprotected” (thereby allowing its authorized removal from the network) This (re)setting can take place e.g. by performing an action on the device itself or via another device in the network and may require appropriate security measures e.g. such as authentication of the device user to secure the functioning of the anti-theft system. These security measures are however outside the scope of the present invention.

The advantages of the system and method of the present invention include simplicity and low cost. A network modified with an embodiment according to the present invention can be reconfigured at any time by adding and deleting components and still be protected from unauthorized removal of component consumer electronic devices. Further, a protection state, according to the present invention, has the advantage that it allows the protection state to be different for different devices at different times and under different conditions, all under the control of the user. Such flexibility is necessary for mobile devices, such as digital cameras and mobile phones that during the day need to enter and leave the home network but at night need to be protected against unauthorized removal from the in-home network.

The foregoing and other features and advantages of the invention will be apparent from the following, more detailed description of preferred embodiments as illustrated in the accompanying drawings in which reference characters refer to the same parts throughout the various views.

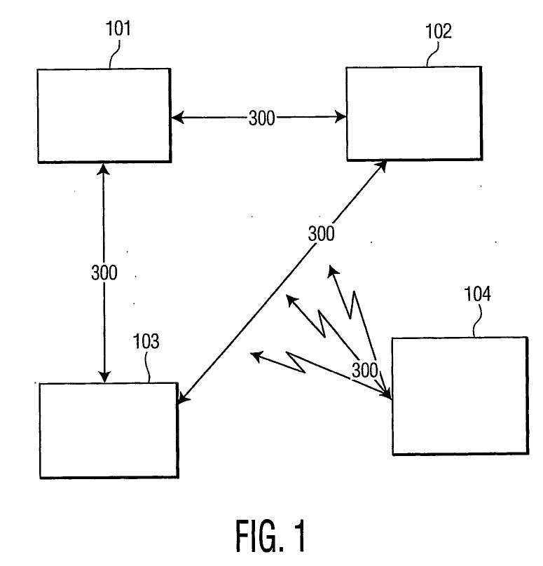

FIG. 1 is a simplified network of consumer devices whereto embodiments of the present invention are to be applied;

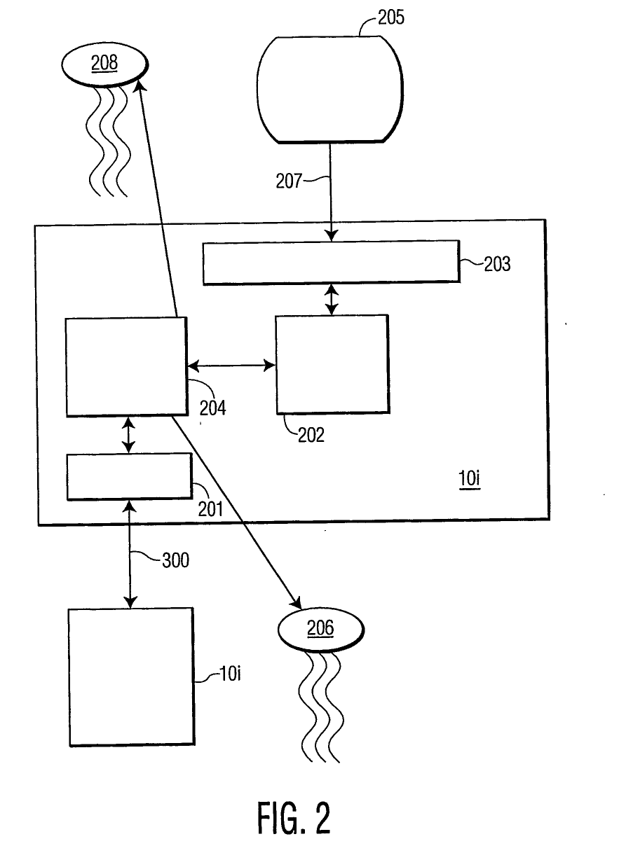

FIG. 2 illustrates an example of a hardware/software system that can be used to perform the present invention;

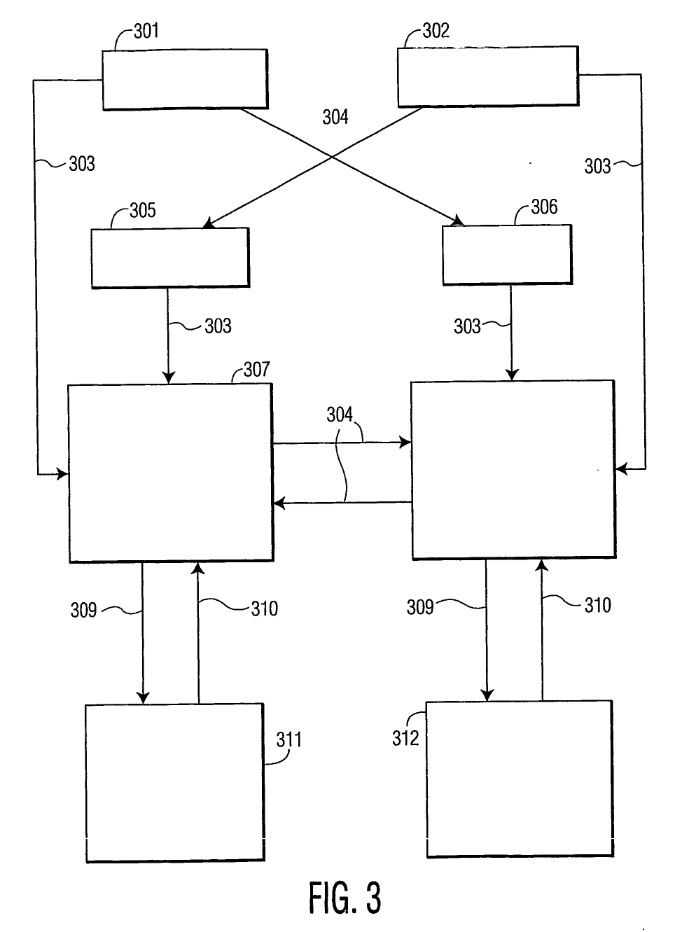

FIG. 3 illustrates a state transition diagram for the protection state of a networked CE device incorporating an embodiment of the present invention.

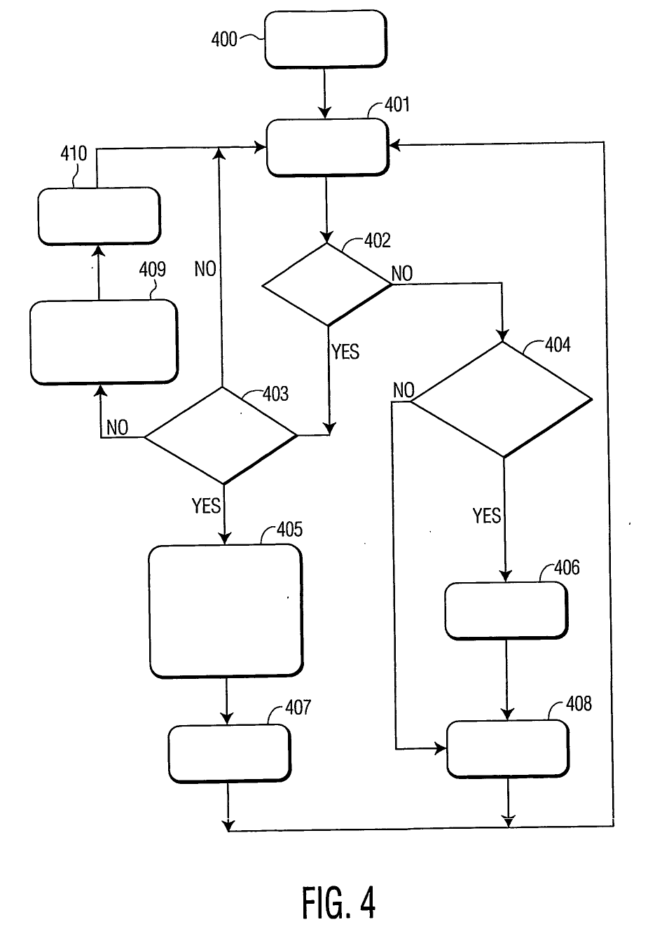

FIG. 4 is a flow chart for the process performed by an inspecting application running on a CE device to detect the removal and insertion of another CE device in the network and to generate and stop an alarm or alert based on the last known protection state of that CE device according to an embodiment of the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

FIG. 1 illustrates a representative in-home network 300 of wired and wireless 10i CE devices whereto embodiments of the present invention are to be applied. As shown in FIG. 1, a CE device 10i is coupled to a plurality of other CE devices 10i, which, through a wired or wireless network, are in communication with each other and inspecting each other via a plurality of wired and wireless channels. The present invention uses a further unspecified device discovery mechanism that is outside the scope of the present invention, e.g. the known mechanisms described above or any other suitable protocol, whereby a CE device 10i modified according to the present invention can detect the insertion or removal of itself and possibly other CE devices 10i in the network. The network 300 shown in FIG. 1 is small for purposes of illustration. In practice most networks could include a much larger number of CE devices 10i.

In a preferred embodiment, illustrated in the example of FIG. 2, the system and method of the present invention provides a way for a CE device 10i to store its own protection state 202, possibly across power on/off cycles of the device. The CE device 10i generates an alarm signal 206 to indicate its unauthorized removal when it detects its own removal from the network 300 if its stored protection state 202 is “protected”. or optionally generate an alert 208 otherwise, indicating its authorized removal from the network. It should be noted that even though the description may refer to terms commonly used is describing particular CE devices, the description and concepts equally apply to other processing systems, including systems having architectures dissimilar to that shown in FIG. 2.

In operation, the transceiver 201 may be coupled to an antenna or wire (not shown) to convert received signals from and transmit desired data over the network 300. The protection state 202 operates under the control of the state set/reset component 203 and has a setting when it comes from the factory. The CE device 10i may also comprise an inspecting application controlled by the inspection control module 204 for detecting the insertion and both the unauthorized and authorized removal from the network 300 of itself or zero or more other CE devices 10i. The inspection control module 204 on CE device 10i regularly transfers in a further unspecified way outside the scope of the present invention, the protection state 202 over the network 300, e.g. as part of the messages used by the known device discovery mechanisms described above or by using any other suitable protocol. This protection state is transferred to the inspection control module 204 on one or more other CE devices 10i inspecting this device. When such other CE device 10i detects that it no longer receives this CE device's 10i protection state, said other CE device will generate an alarm 206 if the last received protection state from this CE device 10i was “protected” or optionally generate an alert 208 otherwise, indicating the authorized removal of this CE device 10i from the network.

The Controller Area Network (CAN) application layer CAL transfers state information about a device as part of its device discovery mechanism, but it does not transfer information on a protection state.

The protection state 202 can be different for different devices at different times or conditions and is under control of the user by interacting with the state set/reset component 203 of each device. This device-, time-, and place- specific user-controlled protection state 202 is applicable, e.g., to mobile consumer electronic devices 10i such as digital cameras, portable MP3 players and mobile phones that during the day frequently enter and leave the (wired or wireless) home network but at night need to be inspected.

Referring to FIG. 2, in a preferred embodiment, a consumer electronic device 10i modified according to the present invention with a protection state 202, does not need to know if and what inspecting application is inspecting its protection state 202, e.g., zero or more other devices 10i or itself. The initiative of inspection lies fully with the inspecting device/application. Therefore, in this embodiment of the present invention each CE device can decide itself, e.g. under control of a user, which other CE devices (zero-configuration) it should inspect thereby giving the user the possibility to increase the robustness of the protection system at the cost of generating more load on the network and devices using e.g. the following possibilities:
there can be more than one inspecting device/application 10i for a CE device thus preventing a single point of failure; and
an inspecting device 10i can itself be inspected by one or more other devices/applications in the network, thus preventing a single point of failure.

Referring to FIG. 2, in a preferred embodiment according to the present invention, the state set/reset component 203 on a device 10i (optionally involving user authentication) can be implemented e.g. as:

an anti-theft button on the device;

a physical key insertion/positioning on the device; and

the insertion/positioning of a smart card; and

a separate configuration device 205 that sends the protection state to be set to the device 10i via a separate wired or wireless configuration link 207 that is not part of the network 300, e.g. an adapted CE remote control device connected via an infrared point-to-point link or an RF identification tag using short range RE links.

In this embodiment, the mechanism to set/reset the protection state is under control of the device manufacturer and can be adapted to the requirements of the device such as size, cost (how bad is it if the device is stolen), security sensitivity (who is allowed to set the protection state, is authentication needed, etc). This embodiment is transparent to device interoperability with the inspecting applications.

Referring to FIG. 3, a CE device can be in one of a protected initial state 301 (protection state is “protected”) or an unprotected initial state 302 (protection state is “unprotected”) when it is received from the manufacturer. A user action may change this initial protection state of the CE device 304 before inserting it 303 in the network 300 or the user may insert the CE device without changing the initial protection state as received from the manufacturer. Depending on the state of the device at the moment the user inserts 303 the device into a network 300, the CE device is either in a protected networking state 307 or an unprotected networking state 308. After insertion a user action may change any number of times the state of the device from the protected networking state 307 to the unprotected networking state 308 and vice versa to enable and respectively disable the authorized removal of the device from the network 300. If the CE device is in the protected networking state and detects 309 its removal from the network 300 the CE device enters the protected stand-alone state 311 and generates an alarm 206 indicating its unauthorized removal from the network. Alternatively, if the CE device is in the unprotected networking state, the device enters the unprotected stand-alone state 312 and optionally generates an alert 208, e.g., a message is displayed on the device, indicating its authorized removal from the network. The generated alarm can be e.g. a call to the authorities, making the device unusable, a flashing light, a repetitive sound, a message displayed on the device, or once or continuously tracking and sending its physical location on the globe to the authorities. For the user the alert must be perceived different from an alarm. An alert can be e.g. a single sound instead of a repetitive sound or a small icon instead of a highlighted message on the display. Thereafter, the CE device may be reinserted in the network 310 from whatever state it is in at the time.

Referring now to FIG. 4, an inspecting application on a CE device 10i inspecting another CE device 10i, after initially setting 400 the previous state to “alarm-alert” receives 401 the current protection state of another CE device 10i it is inspecting after at most n attempts in a further unspecified way outside the scope of this invention (e.g. by transferring the protection state as part of the known device discovery mechanisms described above or any other suitable protocol), or times out 402. If the reception times out before a current protection state is received 402 and if the previous state is “protected” 403 then the inspecting application performs a start alarm 405, sets the previous state to “alarm-alert” 407, and returns to receiving 401 the current protection state of the other CE device 10i. Alternatively if the reception times out but the previous state was not “protected” the inspecting application may optionally perform a start alert 409 followed by setting 410 the previous state to “alarm-alert”. Alternatively, if the current state is received 402 and if the previous state received by the inspecting device or application is “alarm-alert” 404 then the inspecting application performs a stop alarm/alert 406, sets the previous state to the received current state 408, and returns to receiving 401 the current state of the other CE device 10i.

The flow described in FIG. 4 also applies to a self-inspecting application on a CE device 10i that detect its own removal and insertion into the network. In this case the index 10i in FIG. 4 indicates the device where the self-inspecting application is running. Receiving the current protection state 401 in this situation indicates any further unspecified means outside the scope of the present invention from which the CE device can conclude by itself that it is or is not part of the network. These means can e.g. be part of the known device discovery mechanisms described above (e.g. receiving a regular guarding message) or any other suitable protocol.

While the preferred embodiments of the present invention have been illustrated and described, it will be understood by those skilled the art that various changes and modifications may be made, and equivalents may be substituted for elements thereof without departing from the true scope of the present invention. In addition, many modifications may be made to adapt to a particular situation and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

1. A method for detecting when a device having a protection state is removed from a network with one of authorized and unauthorized removal, comprising the steps of:
at least once, setting the protection state to a predetermined state;
inserting the device having the set protection state into the network;
detecting a removal of the device from the network; and
responding by the device detecting a removal in accordance with the protection state of the device whose removal has been detected.

2. The method of claim 1, wherein said device is a consumer electronic device.

3. The method of claim 1, wherein the network is an in-home network.

4. The method of claim 1, further comprising the steps of:
on removal of the device from the network, performing the steps of—
optionally, first setting the protection state to unprotected, and then
removing the device from the network.

5. The method of claim 1, further comprising the steps of:
on reinsertion of the device into the network after a removal, performing the steps of—
optionally, first setting the protection state to protected or unprotected, and then
reinserting the device into the network.

6. The method of claim 1, wherein the predetermined state is one of protected and unprotected.

7. The method of claim 1, wherein said network is at least one of Bluetooth, wired Ethernet (IEEE std 802.3), wireless Ethernet (IEEE std 802.11 a/b/g), Ultra Wide Band (IEEE std 802.15.3) and Zigbee (IEEE std 802.15.4).

8. The method of claim 1, wherein said responding step further comprises the steps of:
generating an alarm on the device that detects a removal, if the protection state of the device whose removal has been detected indicates the device is protected; and
optionally, generating an alert on the device that detects a removal, otherwise.

9. The method of claim 1, wherein said inserting step further comprises reinserting the device in the network after removal.

10. The method of claim 1, wherein said detecting step further comprises the step of transporting the protection state to one or more other devices in the network.

11. The method of claim 10, wherein said detecting step is performed by at least one of the device itself and at least one other device in the network.

12. The method of claim 11, wherein said device and said at least one other device is a consumer electronic device.

13. The method of claim 11, wherein said network is an in-home network.

14. The method of claim 12, wherein the predetermined state is one of protected and unprotected.

15. The method of claim 14, wherein said inserting step further comprises reinserting the device in the network after removal.

16. The method of claim 11, wherein said response is the steps of:
generating an alarm on the device that detects a removal, if the protection state of the device whose removal has been detected indicates the device is protected; and
optionally, generating an alert on the device that detects a removal, otherwise.

17. The method of claim 1, wherein said setting step further comprises the steps of:
providing a set/reset component for the protection state; and
setting said provided protection state by the set/reset component.

18. The method of claim 17, wherein said set/reset component is at least one of a button on the device, a physical key to be inserted/positioned in the device, an input received from another device over the network and a separate configuration device connected via a configuration link,
wherein, said configuration link is not part of said network and is capable of transferring the protection state to be set to the set/reset component.

19. The method of claim 17, wherein the physical key is a smartcard.

20. The method of claim 17, wherein the configuration device and configuration link is a CE remote control using an infrared point-to-point link, respectively.

21. The method of claim 17, wherein the configuration device and configuration link comprise an RF identification tag using a short range RF link, respectively.

22. A method for a device, maintaining a previous and current state for monitoring the protection state of a device in the network, to determine when to start and stop an alarm or alert, comprising the steps of:
setting the previous state to an alarm state and then repeatedly performing the steps of:
receiving the current protection state of a device in the network;
timing out after a predetermined number of attempts to perform the receiving step and then performing the steps of—
a. if the previous state is a protected state performing the steps of—
i. starting an alarm, and
ii. setting the previous state to an alarm-alert state;
b. if the previous state is not a protected state, optionally, performing the steps of—
iii. starting an alert, and
iv. setting the previous state to an alarm-alert state,
if the receiving step does not time out, performing the steps of—
c. if the previous state is an alarm state performing the steps of—
v. stopping one of the alarm and alert, and
vi. setting the previous state to the received current protection state.

23. The method of claim 1, wherein:
said protection state further comprises a previous and a current state; and
said responding step further comprises the method of claim 22.

24. The method of claim 16, wherein:
said protection state further comprises a previous and a current state; and
said responding step further comprises the method of claim 22.

25. A hardware/software system for a device connected to a network to detect one of authorized and unauthorized removal of a device from the network, comprising:
a settable protection state;
a transceiver for sending and receiving messages to and from other devices in the network;
an inspection control module configured to perform at least one of—
detection of removal of the device itself or any other device from the network,
detection of insertion of the device itself or any other device into the network,
setting of the protection state,
resetting of the protection state,
generation of an alarm and, optionally, an alert, and
cessation of an alarm and, optionally, an alert; and
output means for outputting said alarm and, optionally, means for outputting said alert, wherein said alert is generated if the system needs to generate such an alert.

26. The system of claim 25, further comprising a state set/reset component for setting/resetting the settable protection state.

27. The system of claim 26, wherein said state set/reset component is at least one of a button on the device, an input on a screen of the device, an input received via the transceiver from another network device, a physical key to be inserted/positioned in the device, a separate configuration device connected via a wired or wireless configuration link,
wherein, said configuration link is not part of said network and is capable of transferring the protection state to be set to the device.

28. The system of claim 27, wherein the physical key is a smartcard.

29. The system of claim 27, wherein the configuration device and configuration link is a CE remote control using an infrared point-to-point link, respectively.

30. The system of claim 27, wherein the configuration device and configuration link comprise an RF identification tag using a short range RF link, respectively.

31. The system of claim 25 wherein:
said protection state further comprises a previous and a current state; and
said output means is the method of claim 22; and
said alarm is at least one of a call to the authorities, making the device unusable, a flashing light, a repetitive sound, and a message displayed on the device; and
said alert is at least one of a flashing light, a sound, and a message displayed on the device,
wherein, said alarm and said alert are distinguishable by a user such that the alarm indicates an unauthorized removal and the alert indicates an authorized removal of the device from the network.
